(19) United States
(12) Patent Application Publication
(10) Pub. No.: US 2012/0285750 A1
(43) Pub. Date: Nov. 15, 2012

(54) WEIGHT MEASUREMENT SYSTEM FOR ACCURATELY DETERMINING THE WEIGHT OF MATERIAL IN A CONTAINER BEING LIFTED

(75) Inventors: Eamon Hynes, Co. Limerick (IE); Patrick Ryan, Co. Tipperary (IE); Gary O'Riordan, Co. Limerick (IE); Tom Lawlor, Co. Limerick (IE); Tom Golden, Co. Clare (IE)

(73) Assignee: ADVANCED MANUFACTURING CONTROL SYSTEMS LTD., Co. Limerick (IE)

(21) Appl. No.: 13/105,961

(22) Filed: May 12, 2011

(51) Int. Cl. G01G 19/08; G01G 19/00

(52) U.S. Cl. 177/1; 177/139; 177/145

(57) ABSTRACT

A weight measurement system for accurately determining the weight of material in a container being lifted. The system includes a hydraulic system comprising a mechanical lift arm for lifting and emptying a container, a dampener operable on the hydraulic system for reducing and minimising oscillations of the hydraulic system during operation of the mechanical arm, a weight transducer based weighing system for weighing the container during at least one of a lift and after being emptied and to provide an output indicative of each weighing during periods of dampening of the mechanical lift arm, and a processor configured to use at least the outputs of the weighing system to provide a weight of the material in the container.

### FIELD OF INVENTION

This invention relates to the field of load weighing systems. The invention more particularly relates to the weighing of material in a container being lifted. The invention more particularly relates to statically or dynamically determining the weight of material using a hydraulically operated lifting system.

### BACKGROUND INFORMATION

Municipalities and private waste collectors continue to implement new systems and methods to improve the efficiency of the waste and recyclables collection operation. In order to reduce landfill costs, Pay-As-You Throw (PAYT) programs have been developed. These programs change the waste cost model from a flat fee to a unit fee structure where the total waste cost is dependent on the amount of waste the household presents for collection, and the amount of waste diverted to recycling. A unit fee structure can be either volume based or weight based. A volume based waste price structure involves charging the household based on the waste container volume. However, a weight based price structure rewards the household for continuous improvement in their recycling diversion rate and reduction in total waste generated. This results in a more equitable waste cost structure. By combining bin identification and weighing technology the customer can be billed based on total waste weight. This presents a challenge to the waste industry to provide effective waste container identification and weighing capability. The waste must be dynamically weighed as the waste container is lifted and emptied by the waste truck to avoid negatively impacting the rate of waste collection. It is also important to monitor the load carried by a waste truck to address weight restriction safety requirements and to protect against the resultant fines from trucks being overweight.

In typical refuse collection and weighing systems the collection vehicle stops adjacent to the waste container. The loader engages the waste container. The engagement means are supported on a weighing device such as a load cell. The waste container is uniquely identified through an information exchange between the waste container and the loader. The waste container is lifted by the loader. The waste container is weighed a number of times at predetermined points of the lifting cycle known as the weighing window. The lift mechanism continues to lift the waste container, and partially inverts it to empty the content into a receiving area of the waste collection vehicle. After dumping the empty container is returned to its original position. During the downward cycle the waste container is also weighed. The waste weight is calculated by subtracting the downward reading from the upward reading.

However, there are difficulties in using transducers mounted on the lifting element of a waste collection vehicle. The dynamics of the lift process creates significant vibrations due to the powerful hydraulic system. This presents a challenge to the static weighing of a load. The challenge is magnified when attempting to weigh the load dynamically during the lift operation. Problems also include the uneven placement of material in the waste/recycle container, the movement of containers during the lifting cycle and the rough action of the hydraulic system with acceleration and deceleration forces that make dynamic weighing very difficult.

Mechanical vibrations and oscillation create noise signals for the weighing system. The time taken for a complete oscillation to occur is known as the oscillatory period. In order to ‘smooth out’ or average the noise effectively a number of periods of the mechanical oscillation must be captured. However this challenge is further increased due to the inconsistency of the oscillation frequency and amplitude and the limited time available to complete the weighing operation.

Firstly, the oscillation frequency is not consistent. The oscillations vary depending on a number of factors including the weight of the load, load imbalance, engine noise from the waste truck, movement of the mechanical lift arm, uneven friction of mechanical moving parts, and environmental factors such as the strength of the wind.

Secondly, there is a limited time available. The window of opportunity for weighing during the lift cycle can be less than 1 second. In this case, if the mechanical oscillations have a period approaching 1 second, then it is impossible to capture multiple periods in order to enable averaging. Solutions that require slowing down or stopping the lift cycle to allow static weighing have disadvantages because of the reduction in productivity.

Mechanical damping is known in the prior art and is a potential solution to reducing the oscillations in any mechanical system. In the ideal case, damping will result in a faster settling time resulting in more accurate and repeatable weight measurement to be made within the available weighing window. However, mechanical damping devices are influenced by environmental factors such as barometric pressure and temperature, and deliver constant damping independent of the amplitude of oscillations of the mechanical system.

The disadvantages of all damper systems are that they add opposing loads which cause measurement errors that must be compensated for in the weighing process. Mechanical damping arrangements need a custom solution for each lift type. Such mechanical damping systems are 3-dimensional solutions and are complex and costly.

Other proposed solutions limit the out of plane mechanical movement during the lift cycle. Implementing these systems require a number of fundamental limitations. These limitations involve the requirement of new bin lift designs, or a mechanical apparatus that will add additional mechanical deflections that need to be compensated within the weighing system and are unique to each mechanical lift design.

In view of the above, the inventors have identified a need for an accurate weight measurement system for a container being lifted.

These and other features will be better understood with reference to the following figures which are provided to assist in an understanding of the teaching of the invention.

### SUMMARY

These and other problems are addressed by providing a weight measurement system for accurately determining the weight of material in a container being lifted.

Accordingly, a first embodiment of the invention provides a weight measurement system as detailed in claim 1. Advantageous embodiments are provided in the dependent claims.

These and other features will be better understood with reference to the following figures which are provided to assist in an understanding of the teaching of the invention.

### BRIEF DESCRIPTION OF THE DRAWINGS

The present application will now be described with reference to the accompanying drawings in which:

FIG. 1 is a diagram of a waste collection vehicle equipped with a weight measurement system for accurately determining the weight of waste or recyclable material in the waste collection vehicle, according to an embodiment of the present teaching;

FIG. 2 is a block diagram of a part of a hydraulic system included in the weight measurement system, according to an embodiment of the present teaching;

FIG. 3 is a graph illustrating a typical load cell output from an undamped load weighing system and a weight measurement system according to the present teaching; and

FIG. 4 is a graph illustrating a comparison of the spread of weight data using a conventional weight measurement system and a weight measurement system according to the present teaching.

### DETAILED DESCRIPTION OF THE INVENTION

The present teaching has application to any environment where accurate weighing of material in a container is required. Examples of such applications include the lifting of material such as mining ore or the like using hydraulic arms and the transport of that lifted ore to a secondary location. In such environments it is useful to accurately weigh the material that was initially disposed in the container prior to its transfer to the secondary location. In such an exemplary application where the container—typically the bucket of an articulated arm—is well known, one measurement value of the weight will be sufficient in that the bucket is a constant value. For the sake of explanation and not to limit the present teaching to any one application, the teaching will be described with reference to the weighing of waste material such as domestic or commercial refuse which is typically stored in one or more containers which are then lifted during a collection period and the waste previously within the containers is then disposed into the refuse collection vehicle. Such reference to an exemplary waste measurement system will be appreciated as being provided to assist in an understanding of the teaching of the invention and should not be construed as limiting in any fashion.

FIG. 1 is a diagram of a waste collection vehicle 1 equipped with a weight measurement system for accurately determining the weight of waste or recyclable material in the waste collection vehicle 1, according to an embodiment of the present teaching. Referring to FIG. 1, the weight measurement system includes a hydraulic system 3 including a mechanical lift arm 10 for lifting and emptying a waste container 5, and a weight transducer based weighing system for weighing the waste in the waste container 5. A damping system within the hydraulic system 3 is used to reduce and minimise mechanical oscillations (irrespective of their origin) within the weight measurement system. This facilitates more accurate and repeatable weighing as will be described later.

The weight measurement system according to the present teaching can be applied to any type of conventional waste collection vehicle or other vehicle that is used for lifting material and may be used with a side, rear or front loading apparatus. However, for purposes of illustration, the weight measurement system according to the present teaching is described with reference to a front loading apparatus, and specifically a waste collection vehicle incorporating such a front loading apparatus.

The hydraulic system 3 may be arranged at the front of the vehicle 1 and has major components comprising the mechanical lift arm 10 hingedly arranged with the vehicle at a pivot pin 21 and pivotable by operation of a lift cylinder 20 which will be described later. The waste collection vehicle 1 hydraulically pivots the mechanical lift arm 10 by pulling or pushing the lift arm 10.

The lift arm 10 is engageable with the waste container 5 by means of a loader assembly coupled to the lift arm 10. The loader assembly comprises a pivotable engagable arm 6 which is pivoted on the mechanical lift arm 10 at a pivot pin 7. FIG. 1 shows only the left side of the vehicle 1 and the right side is not shown since it would be substantially the same because the hydraulic system 3 is generally symmetric.

The operation of the loader assembly is controlled by the hydraulic system 3 which includes appropriate manual controls in the vehicle cab such as an open/close gripping mechanism control unit having a control stick, extend/retract boom control unit having a control stick, and an on/off motor control unit having a control lever. These controls and associated hydraulic circuits are standard and are understood by those of ordinary skill in the art.

The weighing system can be any non-hydraulic weighing system that provides an indication of the weight of the waste. In this regard, the weighing system may comprise at least one weight transducer 8 which is mounted on the engagable arm 6 for sensing the weight of the waste container 5 and for producing an electrical signal indicative of the weight. The weight transducer 8 may be a load cell such as a strain gauge load cell, a piezo-electric load cell or a compression load cell. However, the weight transducer 8 is not limited thereto. Positioning load cell transducers at opposite locations along a line through the center of mass of the waste container 5 provides accurate readings and tends to minimize errors due to the fact that measurement occurs dynamically during loading and unloading of the waste container 5. The output from the load cell is supplied by means of either a hard-wired conductor or transmitter to an appropriate decoder and on-board computer which processes this information. In an alternative arrangement, the output may be simply stored on the vehicle for subsequent processing.

As indicated above, the output from the load cell provides an electrical signal indicative of the weight of the waste container 5. A single reading may be taken at any time during the upward movement of the waste container 5 prior to the dumping operation. Similarly, the weight of the empty waste container 5 or tare weight can be sensed at the load cell output at any time during the downward movement of the empty container 5 prior to replacing the container 5 on the ground. It is more efficient to establish the weight readings during the upward and downward movement of the container 5 rather than stopping the container 5 during the cycle and negatively impacting the rate of waste collection. An average weight reading may be obtained, which may be computed from a continuous reading or series of readings taken during a portion of the lifting and lowering cycle. The continuous output of the load cells can be monitored during a selected portion of the container movement in a weighing zone and this continuous reading averaged and processed by the on-board computer or other appropriate processing means. The weighing is performed along a predetermined travel distance of the mechanical lift arm 10.

A switch such as a limit switch may be operatively connected to the transducer so that the transducer is energized at a point when a full waste container 5 is supported by the mechanical lift arm 10 and when an empty waste container 5 is supported by the mechanical lift arm 10 for the purpose of determining the weight of the refuse in the waste container 5. This will be described in detail below.

The transducer is desirably always connected to the switching circuit but the output from the circuit is read during periods determined by the switching. In this way there is no settling of the transducer circuit required prior to taking a measurement. It will be understood that this switching is a result of the physical location of the limit switch and if modification is required this will need a physical movement of the switch. In an alternative arrangement the switch may be a rotary resistor which can be remotely managed through an external communication protocol. In such an arrangement the window of reading data may be changed by dynamically moving the operating region or set point of the rotary resistor. Such a rotary resistor is of course exemplary of the type of switching mechanism that may be employed where a remote changing of the measurement window is required.

The weighing process is performed as follows. The loader assembly engages the waste container 5. The waste container 5 is lifted by the mechanical lift arm 10. As the container 5 is lifted the operator may level the container 5 using a method known to those of ordinary skill in the art. At this elevated position, mechanical vibrations and oscillations are experienced in the system. The damping system within the hydraulic system 3 is used to reduce and minimise mechanical oscillations (irrespective of their origin) within the entire weight measurement system. This facilitates more accurate and repeatable weighing. In more detail, the hydraulic system 3 used to actuate the mechanical lift arm 10 is itself a mechanical component part of the complete weight measurement system (when the hydraulic system 3 is pressurised), and thus the oscillation in the entire weight measurement system including the lifting mechanism is mechanically coupled into the hydraulic system 3. Thus, the vibrations and oscillations experienced in the lifting mechanism are damped by the damping system in the hydraulic system 3.

Returning to the operating process, the waste container 5 is weighed a number of times in the weighing zone. The weighing zone may correspond to a time of less than 1 second. The mechanical lift arm 10 continues to lift the waste container 5, and partially inverts it to empty the content into a receptacle 30 of the waste collection vehicle 1. After dumping the empty container 5 is returned to its original position. During the downward cycle the waste container 5 is also weighed. The waste weight is calculated by subtracting the downward reading from the upward reading.

As mentioned above, a rotary resistor may be operatively connected to the load cell transducer so that the output from the transducer may be read at a point or within a window of points when a full container 5 is supported by the mechanical lift arm 10 and when an empty container 5 is supported by the mechanical lift arm 10 for the purpose of determining the weight of the refuse in the container. The rotary resistor may be disposed on the mechanical lift arm 10 and may be directly wired to the load cell transducer or microprocessor.

When the rotary resistor is activated, load cell readings are sampled or taken until the rotary resistor is deactivated. The activation region of the rotary resistor corresponds to the weighing window, and in this way it will be understood that a plurality of individual readings may be taken during any cycle. These multiple readings taken during the weighing window may then be processed such as by use of a decoder and averaged by the on-board computer. In another arrangement raw data may be stored for subsequent processing. In a configuration whereby the measurement computation is done on-board, the gross weight is automatically captured and retained in memory by the weighing system. The mechanical lift arm 10 brings the container 5 to the dumping position and the refuse and waste materials are dumped into the receptacle 30. When the container 5 is emptied, the operator activates the controls to cause the mechanical lift arm 10 to move the container 5 downwardly until the rotary resistor is activated again to begin the weighing of the empty container until the rotary resistor is deactivated to stop the weighing of the empty container. The waste weight is calculated by subtracting the downward reading from the upward reading. In a configuration whereby the weight of the container is known, then it may not be necessary to weigh on both the up and down cycles of the lift as there is no need to factor in and weigh the empty container—it being a fixed value that can be pre-stored. The means of activating the weighing system is not limited to the above description, and any means of activating the weighing system can be used.

As described above, the damping system is part of the hydraulic system 3 and is separate to the weighing system. According to an embodiment of the invention, the damping system may comprise a pressure pulse dampener for actively dampening hydraulic pressure surges. This dampening in the hydraulic system 3 translates directly to dampen mechanical vibrations to enable dynamic weighing.

Hydraulic pressure pulse dampeners are well known in the art and are designed to dampen large peaks or transients of hydraulic fluid pressure. Where these pulses are allowed to propagate through the hydraulic system, damage may be caused to the components of the hydraulic system such as bursting of hydraulic lines or damage to valves, fittings and gauges. The problem is magnified when under certain operating conditions pressure harmonics develop with resultant increase in the pressure pulse frequency and amplitude. In order to minimise system damage, pressure pulse dampeners are inserted. A pressure pulse dampener comprises a pressure accumulator typically divided into two chambers by a diaphragm or membrane. One chamber is filled with a pressurised gas; the other chamber is connected to the hydraulic system. When a hydraulic system pressure increase is experienced that exceeds the pressure in the gas chamber, fluid is allowed to flow into the hydraulic chamber, further compressing the gas. Similarly when the hydraulic system pressure decreases, the energy stored in the gas chamber is delivered back to the hydraulic system. This pressure dampening effect results in a stabilized hydraulic fluid pressure downstream from the pulse dampener device.

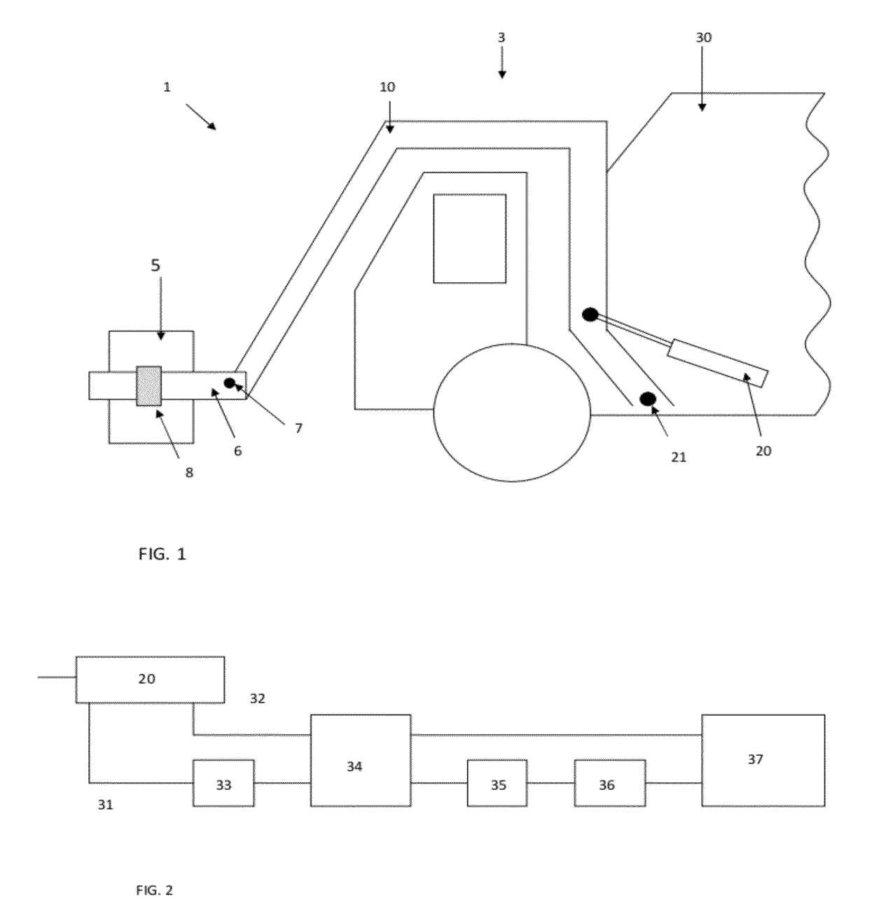

FIG. 2 is a block diagram of a part of the hydraulic system 3, according to an embodiment of the present invention. Referring to FIG. 2, the hydraulic system 3 includes the lift cylinder 20 which is mechanically coupled to the lift arm 10 for moving the lift arm 10, a hydraulic switch 34 for operating the lift cylinder 20, a hydraulic lift line 31 for conveying hydraulic fluid under pressure to operate the lift cylinder 20 and which is connected between the lift cylinder 20 and the hydraulic switch 34, a hydraulic lowering line 32 for releasing hydraulic fluid from the lift cylinder to lower the lift arm 10 and which is connected between the lift cylinder 20 and the hydraulic switch 34, a pressure pulse dampener 33 for actively dampening hydraulic pressure surges, a pump 36 and a reservoir 37. The hydraulic system 3 may optionally comprise a relief valve 35. According to an embodiment of the present invention, the pressure pulse dampener 33 is disposed in the hydraulic system 3 adjacent to the load. The pressure pulse dampener 33 may be disposed on the hydraulic lift line 31, on the load side of the hydraulic switch 34 as the load of the full waste container 5 is at a maximum and the mechanical lift arm 10 is in opposition to gravity forces. Undamped mechanical vibrations and oscillations increase with the weight of the load. On the down lift cycle, the waste container 5 is empty, and the gravity forces are in the same direction as the lift.

When the weighing system is activated to measure the weight of the loaded and empty waste container 5, the oscillations and vibrations in the entire system are damped by the pressure pulse dampener 33, thereby obtaining more accurate load cell readings.

According to an embodiment, the pressure setting of the pressure accumulator of the pressure pulse dampener 33 is set at the low end of the typical pressure required to lift a waste container load. Accordingly, the dampener will provide dampening during the majority of lifts over a range of loads. In this way the weight measurements will be measured from a damped system providing thereby the accuracy enabled using the present teaching. Desirably, the pressure accumulator size is selected to meet the maximum range of waste container load.

Unlike the 3-dimensional mechanical system, the hydraulic system 3 can be considered a 1-dimensional system and this greatly simplifies the damping system design. The damping mechanism disposed within the hydraulic system 3 couples mechanically into the 3-dimensional mechanical system. Thus, a significant advantage of this damping system is its independence from the mechanical system design. It will therefore be appreciated that a system in accordance with the present teaching can be used on multiple lift designs. In this regard, while only one lift design has been described herein, the damping system can be retrofitted into multiple existing lift designs, is inexpensive, and has no additional mechanical moving parts (e.g. bearings) that could impact reliability.

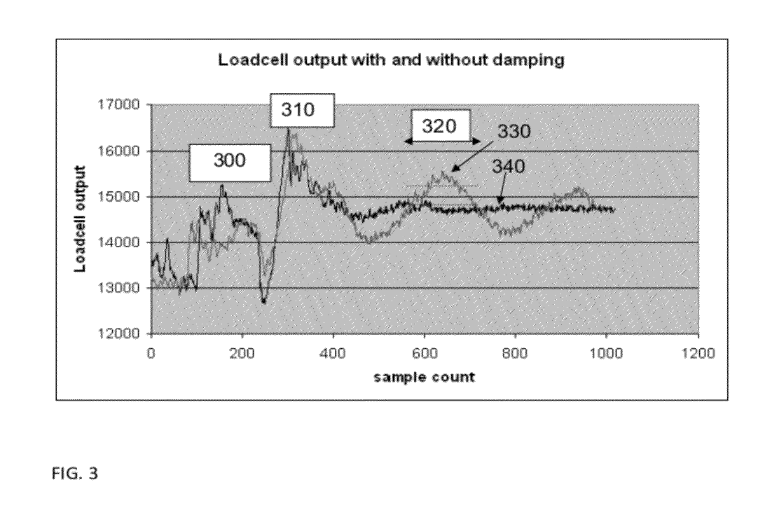

FIG. 3 is a graph illustrating a typical load cell output from an undamped load weighing system and a weight measurement system according to an embodiment of the present invention. Referring to FIG. 3, the X axis represents a continuous output of a load cell during the engagement of a waste container by the load arm of a waste collection vehicle and during the upward lift of the waste container. In an initial region 300, the initial load cell output fluctuations represent the engagement of the waste container with the mechanical lift arm. The lift proper of the waste container begins at the position marked by the point 310 which represents the start of the lift. The position of the weighing zone in the lift cycle is labelled as the region 320. This represents the window of opportunity to capture the weight of the waste container on the upward lift.

The ‘undamped’ line 330 represents the undamped load weighing system. Significant oscillations in the load cell output are observed. Note that a full oscillatory period has not been completed within the weighing zone. As discussed above, averaging of a partial oscillatory period will result in measurement error.

The ‘damped’ line 340 represents the load cell output from the weight measurement system according to the present teaching. The pressure pulse dampener in the hydraulic system which dampens hydraulic pressure surges translates directly to dampening mechanical vibrations in the mechanical lift arm.

As discussed previously, not all data output from the load cell is selected for calculating the weight. In this regard, the data used to calculate the weight of the contents is output during a weighing window corresponding to a period in the lift cycle after the container is engaged and has begun to be lifted, and if a second set of measurements corresponding to an empty container are required at another period when the empty container is being lowered back to its original position after the contents of the container have been transferred to a secondary location. As can be seen from FIG. 3, the weighing window is selected after the load cell output fluctuations have settled and comprises a period in time and as such may comprise a plurality of individual measurements which can be processed for statistical purposes. As described above, a rotary resistor or limit switch can be employed to trigger the weighing window. A rotary resistor has the advantage of being capable of being remotely managed through an external communication protocol without having to be physically moved. In such an arrangement the window of reading data may be changed by dynamically moving the operating region or set point of the rotary resistor. As the switch is connected to the load cell transducer, the outputs from the transducer during the weighing window are processed by a processor to determine the weight.

The undamped average load cell output overestimates the load, while the damped result obtained using the damping system according to the present teaching provides a more accurate representation of the final settled load cell output.

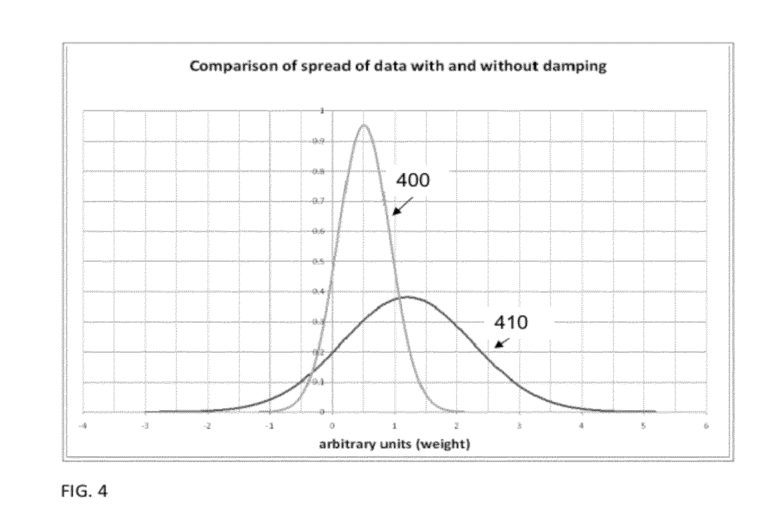

FIG. 4 is a graph illustrating a comparison of the spread of weight data using a conventional weight measurement system and a weight measurement system according to the present teaching. Referring to FIG. 4, the line 400 shows weight data using a waste measurement system according to present invention whereas the line 410 shows weight data using a conventional waste measurement system. It is clear that a significant improvement in data spread is achieved with the addition of the pulse dampener in the hydraulic system. This improvement in weight accuracy enables an accurate load weighing system with transducers to be mounted on the lift arm of the waste collection vehicle, as described above.

It will be appreciated that the provision of a dampener on the lifting arm in accordance with the present teaching is advantageous in prolonging the operable lifetime of the lifting arm and associated components. The environment within which a refuse collection vehicle operates and the nature of the containers being lifted by the lifting arm can result in many shocks being imparted onto and through the lifting arm during its normal usage. These shocks can result from both the coupling and de-coupling of containers to the lifting arm. They can also result from swaying or movement of the container during the lifting cycle. By employing a dampener within the lifting arm, such movement can be controlled or limited to one dimension which can then be dampened so as to lessen any shocks that are transmitted through the mechanical components thereby reducing potential damage to those components.

The words comprises/comprising when used in this specification are to specify the presence of stated features, integers, steps or components but does not preclude the presence or addition of one or more other features, integers, steps, components or groups thereof.

While the present invention has been described with reference to some exemplary arrangements it will be understood that it is not intended to limit the teaching of the present invention to such arrangements as modifications can be made without departing from the spirit and scope of the present invention. In this way it will be understood that the invention is to be limited only insofar as is deemed necessary in the light of the appended claims.

1. A weight measurement system for accurately determining the weight of a material in a container being lifted, the system comprising:
a hydraulic system comprising a mechanical lift arm for lifting and emptying a container;
a dampener operable on the hydraulic system for reducing and minimising oscillations of the hydraulic system during operation of the mechanical arm;
a weight transducer based weighing system for weighing the container during at least one of a lift and after being emptied and to provide an output indicative of each weighing during periods of dampening of the mechanical lift arm,
a processor configured to use at least the outputs of the weighing system to provide a weight of the material in the container.

2. The weight measurement system of claim 1, wherein the hydraulic system further comprises:
a lift cylinder for moving the lift arm, which is mechanically coupled to the lift arm;
a hydraulic switch for operating the lift cylinder;
a hydraulic lift line for conveying hydraulic fluid under pressure to operate the lift cylinder, wherein the hydraulic lift line is connected between the lift cylinder and the hydraulic switch; and
a hydraulic lowering line for releasing hydraulic fluid from the lift cylinder to lower the lift arm, wherein the hydraulic lowering line is connected between the lift cylinder and the hydraulic switch.

3. The weight measurement system of claim 2, wherein the lift cylinder pulls the mechanical lift arm to pivot for lifting a container.

4. The weight measurement system of claim 2, wherein the lift cylinder pushes the mechanical lift arm to pivot for lifting a container.

5. The weight measurement system of claim 2, wherein the dampener is disposed on the hydraulic lift line.

6. The weight measurement system of claim 2, wherein the dampener is disposed adjacent to a loaded container.

7. The weight measurement system of claim 2, wherein the dampener comprises a pressure pulse dampener.

8. The weight measurement system of claim 7, wherein a pressure accumulator of the pressure pulse dampener is selected to meet the maximum range of container load.

9. The weight measurement system of claim 1, wherein the weighing system comprises:
an engagement device for engaging a container, wherein the engagement device is coupled to the mechanical lift arm;
at least one weight transducer disposed on the engagement device; and
means for determining a weighing window during movement of the lift arm, the outputs from the at least one transducer being provided from measurements taken within this window and providing an output indicative of each weighing during the periods of dampening of the mechanical lift arm.

10. The weight measurement system of claim 9, wherein the at least one weight transducer comprises a load cell.

11. The weight measurement system of claim 10, wherein the load cell comprises a strain gauge load cell, a piezo-electric load cell or a compression load cell.

12. The weight measurement system of claim 10, wherein the load cell provides an electrical output signal indicative of the weight supported by the engagement device.

13. The weight measurement system of claim 9, configured such that operably when the engagement device engages a loaded container, the lift arm raises the loaded container, the weighing system weighs the loaded container on the upward movement of the lift arm, the lift arm transfers the contents of the container to a secondary location, and the weighing system weighs the empty container on the downward movement of the lift arm and subtracts the weight of the empty container from that of the loaded container to determine the weight of the contents.

14. The weight measurement system of claim 9, wherein the means for determining a weighing window comprises a rotary resistor or a limit switch.

15. The weight measurement system of claim 1 whereby the hydraulic system is operable to lift a range of weights, the dampener being cooperable with the hydraulic system to dampen the mechanical system through the range of weights.

16. The weight measurement system of claim 15 whereby the dampener comprises a pressure accumulator, the pressure accumulator having a size selected to meet a maximum range of weights to be lifted by the hydraulic system.

17. The system of claim 1 wherein the dampener is in fluid communication with the hydraulic system.

18. The system of claim 1 wherein the dampener is integrally formed with the hydraulic system.

19. The system of claim 1 wherein the dampener is formed separately to the hydraulic system.

20. The system of claim 1 wherein the dampener is a hydraulic dampener.

21. The system of claim 1 wherein the weight transducer based weighing system is separate to the hydraulic system.

22. A loading apparatus comprising the system of claim 1.

23. The apparatus of claim 22, being a front, side or rear loading apparatus.

24. A method of measuring the weight of material in a container being lifted, the method comprising:
using a hydraulic system having a mechanical lift arm to lift and empty a container; and
providing a dampener operable on the hydraulic system for reducing and minimising oscillations of the hydraulic system during operation of the mechanical arm;
providing a weight transducer based weighing system for weighing the container during at least one of a lift and after being emptied and to provide an output indicative of each weighing during periods of dampening of the mechanical lift arm; and
providing a processor configured to use at least the outputs of the weighing system to provide a weight of the material in the container.

25. The method of claim 24 comprising:
using the weighing system to weigh the container on an upward movement and downward movement of the lift arm,
subtracting the weight of the empty container from that of the loaded container to determine the weight of the material.

26. A refuse collection vehicle comprising:
a hydraulic system comprising a mechanical lift arm for lifting and emptying a container;
a dampener operable on the hydraulic system for reducing and minimising oscillations of the hydraulic system during operation of the mechanical arm;
a lift cylinder for moving the lift arm, which is mechanically coupled to the lift arm;
a hydraulic switch for operating the lift cylinder;
a hydraulic lift line for conveying hydraulic fluid under pressure to operate the lift cylinder, wherein the hydraulic lift line is connected between the lift cylinder and the hydraulic switch; and
a hydraulic lowering line for releasing hydraulic fluid from the lift cylinder to lower the lift arm, wherein the hydraulic lowering line is connected between the lift cylinder and the hydraulic switch.

27. The refuse collection vehicle of claim 26, wherein the dampener is disposed on the hydraulic lift line.

28. The refuse collection vehicle of claim 26, wherein the dampener is disposed adjacent to a loaded container.

29. The refuse collection vehicle of claim 26, wherein the dampener comprises a pressure pulse dampener.

30. The refuse collection vehicle of claim 29, wherein a pressure accumulator of the pressure pulse dampener is selected to meet the maximum range of container load.
